(19) United States
(12) Patent Application Publication
(10) Pub. No.: US 2024/0425756 A1
(43) Pub. Date: Dec. 26, 2024

(54) POLYMERIC FLAME RETARDANT SYNERGIST AND THE METHOD OF PRODUCING IT AND ITS FORMULATION FOR POLYAMIDES

(71) Applicant: Agency for Science, Technology and Research, Singapore (SG)

(72) Inventors: Jun Hua Kong, Singapore (SG); Songlin Liu, Singapore (SG); Qi Feng Lim, Singapore (SG); Qun Ye, Singapore (SG); Warintorn Thitsartarn, Singapore (SG); Chaobin He, Singapore (SG)

(21) Appl. No.: 18/708,316

(22) PCT Filed: Nov. 17, 2022
(86) PCT No.: PCT/SG2022/050835

§ 371 Date: May 8, 2024

(30) Foreign Application Priority Data
Nov. 23, 2021 (SG) 10202113030Y

(51) Int. Cl. C09K 21/14; C08G 12/34; C08G 12/40; C08L 77/02

(52) U.S. Cl. CPC C09K 21/14; C08G 12/34; C08G 12/40; C08L 77/02; C08L 2201/02

(57) ABSTRACT

A flame retardant synergist including a repeating unit including a backbone represented by a formula of:

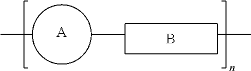

where moiety A is derived from a substituted triazine having at least two amino groups, and where moiety B is derived from a dialdehyde having a terminal aldehyde. Furthermore, moiety A and moiety B are bonded via a —C—N— linkage formed from having one of the at least two amino groups reacted with the terminal aldehyde, where n ranges from 5 to 1000. Additionally, one or more side units extend from the backbone, where the one or more side units are derived from 9,10-dihydro-9-oxa-10-phosphaphenanthrene 10-oxide or a derivative thereof. Furthermore, a flame retardant polymer composite that includes a polymer, the flame retardant synergist, and a flame retardant additive, is disclosed herein. Methods of forming the flame retardant synergist and the flame retardant polymer composite are further disclosed herein.

### CROSS-REFERENCE TO RELATED APPLICATION

This application claims the benefit of priority of Singapore Patent Application No. 10202113030Y, filed 23 Nov. 2021, the content of it being hereby incorporated by reference in its entirety for all purposes.

### TECHNICAL FIELD

The present disclosure relates to a flame retardant synergist and its method of production. The present disclosure also relates to a flame retardant polymer composite containing the flame retardant synergist, and a formulation for forming the flame retardant polymer composite, wherein the formulation involves the flame retardant synergist.

### BACKGROUND

In practical usage and research domain, many chemical structures and formulations may have been developed and used as flame retardant additives, particularly flame retardant synergists, in flammable polymers.

However, technical issues seem to still remain in the following aspects: (1) the existence of halogen in the chemical structures, if present, which tends to be harmful to the environment and human, (2) most traditionally developed chemical structures tend to be small molecules, which tend to render relatively low thermal stability and poor aging resistance due to gradual leaching of the small molecules during long term storage, and (3) relatively high dosage of flame retardant additive (e.g. synergist) tends to be required to achieve a desirable flame retardant performance, e.g. UL94 V0 rate (a flame retardancy standard rating) in most of the applications, while sacrificing other properties (especially mechanical strength).

In one example, a high loading of flame retardant synergist of 12.5 weight percent (wt %) or more was required to achieve flame retardancy of a polymer. However, higher cost was incurred, and the polymer incorporated with such high loading of the flame retardant additive suffered in terms poorer mechanical properties and processability. The same adverse effects were observed in another example using 50 wt % or more of an inorganic flame retardant synergist in a polymer.

In addition, traditionally available flame retardant synergists incorporated in polymers may not match the polymer's burning behaviour (melting, degradation, radical release, etc.), which may render undesirable or distinct changes to the original properties of the polymer, further complicating the polymer's use.

There is thus a need to provide for a solution that addresses one or more of the limitations mentioned above. The solution should at least provide for a flame retardant synergist having a chemical structure, and also flame retardant formulations, which are able to address one or more of aforesaid issues. The solution should also consider the thermal degradation behaviour of the flame retardant synergist so as to match that of a polymer (which the synergist is to be incorporated into) for better fire protection.

### SUMMARY

In a first aspect, there is provided for a flame retardant synergist comprising:
a repeating unit comprising:
   a backbone represented by a formula of:

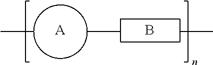

wherein moiety A is derived from a substituted triazine having at least two amino groups;
wherein moiety B is derived from a dialdehyde having a terminal aldehyde;
wherein moiety A and moiety B are bonded via a —C—N— linkage formed from having one of the at least two amino groups reacted with the terminal aldehyde;
wherein n ranges from 5 to 1000;
and
   one or more side units extending from the backbone, wherein the one or more side units are derived from 9,10-dihydro-9-oxa-10-phosphaphenanthrene 10-oxide or a derivative thereof.

In another aspect, there is provided for a method of forming the flame retardant synergist described in various embodiments of the first aspect, the method comprising:
dissolving a substituted triazine and a dialdehyde in a mixture of organic solvents, wherein the substituted triazine has at least two amino groups and the dialdehyde has a terminal aldehyde to form a first reaction mixture; and
mixing 9,10-dihydro-9-oxa-10-phosphaphenanthrene 10-oxide or a derivative thereof with the first reaction mixture.

Various embodiments of the first aspect and the method of forming the flame retardant synergist described in various embodiments of the first aspect can be understood from a non-limiting example described in FIGS. 1A to 1B and 2.

In another aspect, there is provided a flame retardant polymer composite comprising:
a polymer;
the flame retardant synergist described in various embodiments of the first aspect; and
a flame retardant additive.

In another aspect, there is provided for a method of producing the flame retardant polymer composite described in various embodiments of aforesaid aspect, the method comprising:
mixing the flame retardant synergist described in various embodiments of the first aspect with a flame retardant agent to form a pre-mix; and
compounding the pre-mix with a polymer to form the flame retardant polymer composite.

### BRIEF DESCRIPTION OF THE DRAWINGS

The drawings are not necessarily to scale, emphasis instead generally being placed upon illustrating the principles of the present disclosure. In the following description, various embodiments of the present disclosure are described with reference to the following drawings, in which:

FIG. 1A shows a chemical structure of a synergist of the present disclosure (left image) and a thermal gravimetric analysis (TGA) plot (right image) of the synergist shown in the left image. “n” can range from 5 to 1000.

FIG. 1B shows the chemical structure of the same synergist in left image of FIG. 1A. FIG. 1B shows the different functional group or moiety responsible for each flame retardancy mechanism. “n” can range from 5 to 1000. The moiety A derived from a substituted triazine having at least two amino groups is capable of releasing inert gas(es) (e.g. nitrogen) in the presence of heat (e.g. 200° C. to 300° C., 200° C. to 400° C., 300° C. to 400° C.). The moiety B derived from a dialdehyde having a terminal aldehyde confers thermal stability to the synergist due to the existence of multiple aromatic rings. The one or more side units, derived from 9,10-dihydro-9-oxa-10-phosphaphenanthrene 10-oxide or a derivative thereof, confer the synergist char forming capability in the solid phase due to the release of phosphate and/or phosphite units and confer radical scavenging capability in the gaseous phase due to the release of P· and PO· radicals. The inert gas released from moiety A helps (1) expand any formed char phase for a better protection and (2) dilute any surrounding oxygen concentration to suppress any burning. The char forming capability helps to form a char layer during burning so as to stop further burning. The released P· and PO· radicals capture the ·OH and ·H radicals and cease the propagation of the fire.

FIG. 2 shows a one-pot synthesis route of forming the synergist of FIG. 1A. “n” can range from 5 to 1000.

FIG. 3 shows the burning behavior of various samples under a UL 94 standard test. The samples include neat (pure) polyamide 6 (PA6), composites of PA6 containing ADP at different loadings, composites of PA6 containing Exolit® OP 1314 at different loadings, and composites of PA6 containing the present synergist of MTD/TPA-DOPO and ADP at different loadings. Further details of the various polymer composite samples are described in example 3A herein further below.

FIG. 4 is a TGA plot comparing the thermal degradation behavior of each material, i.e. neat PA6, Exolit® OP 1314 and MTD/TPA-DOPO/ADP (MTD/TPA-DOPO to ADP is at a weight ratio 1:3).

FIG. 5 is a table showing the mechanical properties of various samples. The samples include neat PA6, a composite of PA6 containing ADP at loading of 12.5 wt % (denoted as PA6_ADP-12.5 wt %), a composite of PA6 containing Exolit® OP 1314 at a loading of 12.5 wt % (denoted as PA6_Exolit 1314-12.5 wt %), and composites of PA6 containing MTD/TPA-DOPO and ADP mixed at a weight ratio of 1:3 with different loadings (of MTD/TPA-DOPO and ADP) at 6 wt % and 8 wt % (denoted as PA6 MTD/TPA-DOPO/ADP-1/3-6 wt % and PA6 MTD/TPA-DOPO/ADP-1/3-8 wt %, respectively).

FIG. 6 shows the chemical structure of a substituted triazine having the substituent group R, or a triazine derivative, and the various substituent groups denoted by R.

FIG. 7 shows the chemical structure of a dialdehyde (referred to as oxaldehyde or ethanedial) or a dialdehyde derivative and the various substituent groups denoted by X. m may range from 1 to 10, 1 to 6, etc.

FIG. 8 shows the chemical structure of DOPO and a derivative thereof.

### DETAILED DESCRIPTION

The following detailed description refers to the accompanying drawings that show, by way of illustration, specific details and embodiments in which the present disclosure may be practised.

Features that are described in the context of an embodiment may correspondingly be applicable to the same or similar features in the other embodiments. Features that are described in the context of an embodiment may correspondingly be applicable to the other embodiments, even if not explicitly described in these other embodiments. Furthermore, additions and/or combinations and/or alternatives as described for a feature in the context of an embodiment may correspondingly be applicable to the same or similar feature in the other embodiments.

The present disclosure relates to a flame retardant synergist and its method of production. The present disclosure also relates a flame retardant polymer composite containing the flame retardant synergist and its method of production.

Advantageously, the present flame retardant synergist significantly enhances flame retardancy of a polymer even when a lower amount is used (i.e. lower loading of the flame retardant synergist in the polymer) as opposed to a flame retardant polymer incorporated with a traditional flame retardant agent. In other words, even with the lower loading, the present flame retardant polymer composite can achieve a standard of UL94 V0 rate.

Further advantageously, the flame retardant synergist of the present disclosure is able to enhance flame retardancy of a polymer without compromising the mechanical properties of the polymer, or even improve the mechanical properties of the polymer. Hence, the present synergist confers a balance between flame retardancy and mechanical properties for producing a flame retardant polymer composite. The present synergist can be compatibly incorporated into a polymer such as a thermoplastic. Non-limiting examples of the thermoplastic may be, for example, polyamide, polyethylene, etc.

Details of various embodiments of the present synergist and advantages associated with the various embodiments are now described below. Where the embodiments and advantages have been described in the example section herein further below, they shall not be iterated for brevity.

In the present disclosure, there is provided a flame retardant synergist comprising a repeating unit, the repeating unit may comprise a backbone represented by a formula of:

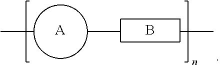

In the present disclosure,

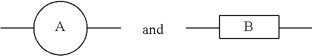

may be referred to as moiety A and moiety B, respectively.

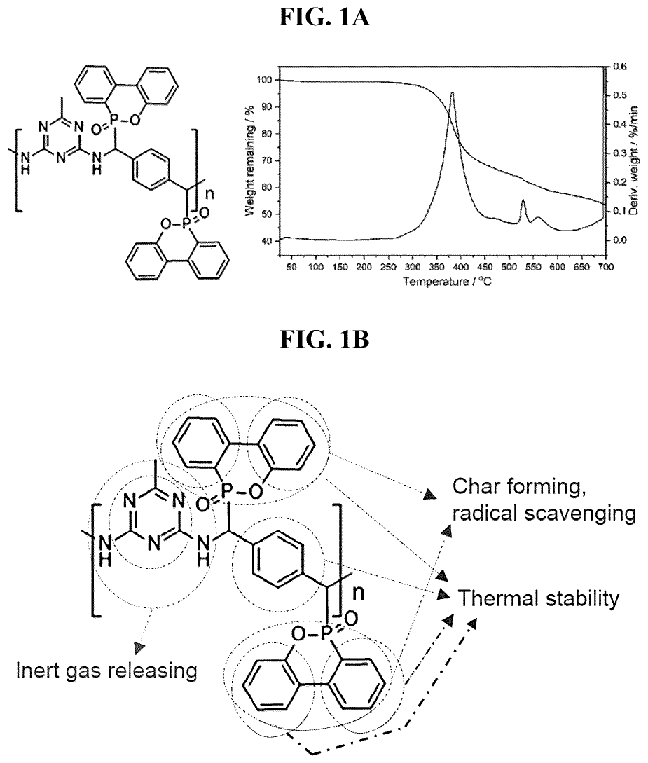

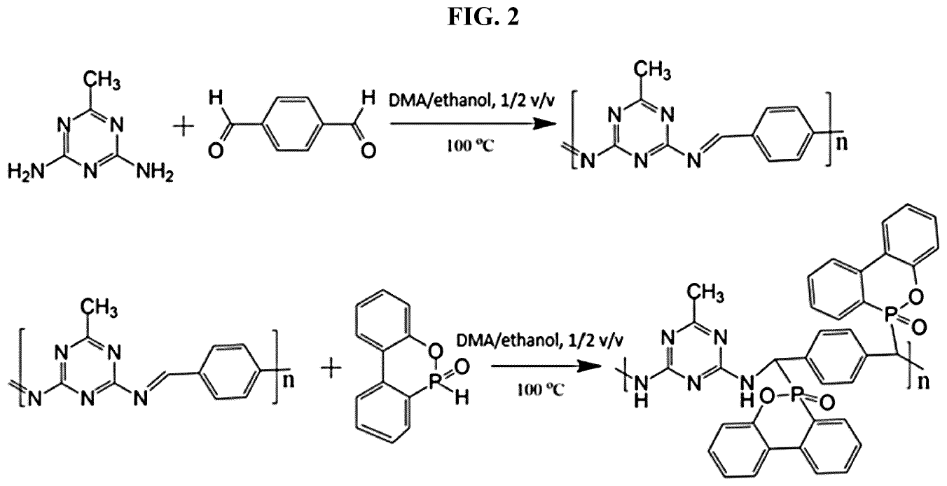

In various embodiments, moiety A may be derived from a substituted triazine having at least two amino groups. Moiety B may be derived from a dialdehyde having a terminal aldehyde. Moiety A and moiety B may be bonded via a —C—N— linkage formed from having one of the at least two amino groups reacted with the terminal aldehyde. This can be seen and understood from the chemical structures in FIG. 1A, FIG. 1B and FIG. 2. In various embodiments, n may range from 5 to 1000, or any range or value within 5 to 1000. The term “terminal aldehyde” in the context of the present disclosure means there is a —CHO functional group located at an end of the dialdehyde or at an end of a compound (e.g. a dialdehyde derivative).

In various embodiments, the backbone, and understandably the repeating unit, may comprise one or more side units extending from the backbone. The one or more side units may be derived from 9,10-dihydro-9-oxa-10-phosphaphenanthrene 10-oxide or a derivative thereof.

In various embodiments, the flame retardant synergist is absent of a halogen and/or a halide.

In various embodiments, the substituted triazine may be:

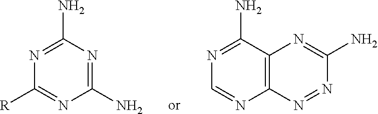

wherein R may be selected from the group consisting of hydrogen, C₁₋₆alkyl,

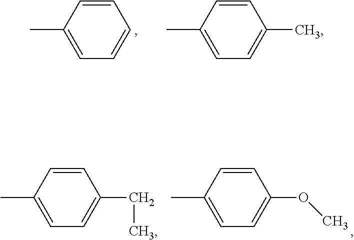

—O—CH₃, —N—(CH₂CH₃)₂, —CH═CH₂,

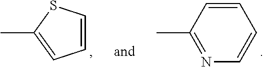

In various embodiments, the dialdehyde may be:

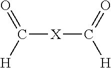

wherein X may be selected from the group consisting of a bond, —(CH₂)ₘ—, —(CH₂)₂—NH—(CH₂)₄—NH—(CH₂)₂—,

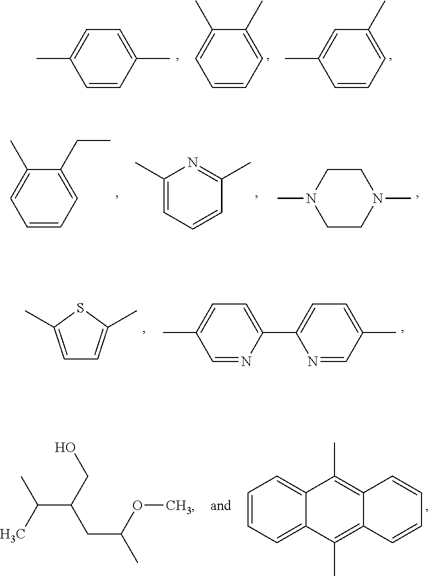

and wherein m may range from 1 to 10.

In various embodiments, the one or more side units may be derived from

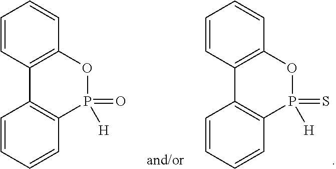 [SMILES: O=[PH]1Oc2ccccc2-c2ccccc21 ; S=[PH]1Oc2ccccc2-c2ccccc21]

In various embodiments, the flame retardant synergist may comprise:

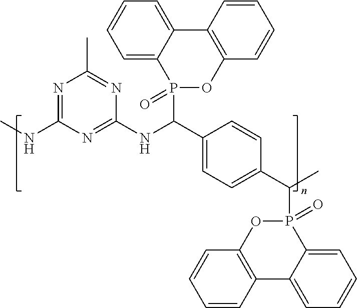

wherein n ranges from 5 to 1000, or any range or value within 5 to 1000.

The present disclosure also provides for a method of forming the flame retardant synergist described in various embodiments of the first aspect. Embodiments and advantages described for the synergist of the first aspect can be analogously valid for the present method of forming the synergist subsequently described herein, and vice versa. Where the various embodiments and advantages have already been described above and in the examples demonstrated further hereinbelow, they shall not be iterated for brevity.

In various embodiments, the method may comprise dissolving a substituted triazine and a dialdehyde in a mixture of organic solvents, wherein the substituted triazine has at least two amino groups and the dialdehyde has a terminal aldehyde to form a first reaction mixture, and mixing 9,10-dihydro-9-oxa-10-phosphaphenanthrene 10-oxide or a derivative thereof with the first reaction mixture.

In various embodiments, the mixture of organic solvents may comprise an alcohol and dimethylacetamide.

In various embodiments, the dissolving and/or the mixing may be carried out at a temperature of 80° C. to 150° C.

In various embodiments, the dissolving may be carried out for a duration of more than 12 hours.

In various embodiments, the mixing may be carried out for a duration of at least 48 hours.

The present disclosure further provides a flame retardant polymer composite. Embodiments and advantages described for the synergist of the first aspect can be analogously valid for the present composite subsequently described herein, and vice versa. Where the various embodiments and advantages have already been described above and in the examples demonstrated further hereinbelow, they shall not be iterated for brevity.

The flame retardant polymer composite may comprise a polymer, the flame retardant synergist described in various embodiment of the first aspect, and a flame retardant additive.

In various embodiments, the polymer may be a thermoplastic. The thermoplastic may comprise a polyamide or a polyethylene.

In various embodiments, the flame retardant polymer composite may further comprise a char forming agent and/or a blowing agent. The char forming agent forms a protective char layer either through self-char formation or carbonizing the polymer (e.g. carbonizing at least a part of the polymer) during the burning of the composite, which helps stop any further burning. The char forming agent may comprise a carbon source or a mineral material which can be easily carbonized to form a carbon phase with high carbon yield. In certain non-limiting instances, the char forming agent may (1) release water to cool the flame and the composite hence reducing and/or eliminating energy to the fire, (2) easily synergize with other flame retardant additives, and/or (3) suppress smoke. The blowing agent may be a compound that releases inert gas to (1) expand the formed char phase for a better protection and (2) dilute any surrounding oxygen concentration to suppress any burning. The degradation temperature of both the char forming agent and the blowing agent may be compatible for use together.

The present disclosure further provides for a method of producing the flame retardant polymer composite as described above. Embodiments and advantages described for the synergist of the first aspect and for the flame retardant polymer composite can be analogously valid for the method of forming the composite subsequently described herein, and vice versa. Where the various embodiments and advantages have already been described above and in the examples demonstrated further hereinbelow, they shall not be iterated for brevity.

The method may comprise mixing the flame retardant synergist described in various embodiments of the first aspect with a flame retardant agent to form a pre-mix, and compounding the pre-mix with a polymer to form the flame retardant polymer composite.

In various embodiments, the flame retardant synergist and the flame retardant agent may be mixed in weight ratio of 1:3 to 1:4, for example, 1:3.

In various embodiments, the loading of the flame retardant synergist and the flame retardant additive in the flame retardant polymer composite may be less than 12.5 wt %. There may be a minimum loading of the flame retardant synergist in certain non-limiting embodiments to achieve the UL94 V0 rating. In certain non-limiting instances, the lower the minimum loading, the flame retardancy efficacy of the flame retardant additive may be higher. Any loading of the flame retardant synergist higher than the minimum loading understandably achieves UL94 V0 rating. Advantageously, with the present synergist, a minimum loading of about 6 wt % can achieve the UL 94 V0 rating as opposed to traditional flame retardant agent which requires a higher minimum loading of 12.5 wt %.

In the context of various embodiments, the articles “a”, “an” and “the” as used with regard to a feature or element include a reference to one or more of the features or elements.

In the context of various embodiments, the term “about” or “approximately” as applied to a numeric value encompasses the exact value and a reasonable variance.

As used herein, the term “and/or” includes any and all combinations of one or more of the associated listed items.

Unless specified otherwise, the terms “comprising” and “comprise”, and grammatical variants thereof, are intended to represent “open” or “inclusive” language such that they include recited elements but also permit inclusion of additional, unrecited elements.

### EXAMPLES

The present disclosure relates to a flame retardant synergist that is halogen-free, has long molecular chain, high thermal degradation temperature and high flame retardant efficacy. The present disclosure also relates to a method of producing the synergist. The present disclosure further relates to a flame retardant formulation for developing a flame retardant polymer composite. The flame retardant formulation is capable of significantly enhancing the (i) flame retardancy of a polymer and (ii) mechanical performance or at least not compromising the mechanical performance of the polymer. The polymer can be a thermoplastic, such as a polyamide. The developed formulation of the present disclosure involves a synergist having the advantages of (1) requiring significantly reduced loading as compared to traditional additives for achieving UL94 V0 rate (a flame retardant standard rating) and (2) flame retardancy without compromising mechanical properties.

The flame retardant synergist of the present disclosure is able to synergistically and dynamically integrate different flame retardancy mechanisms (e.g. char forming, radical scavenging, inert gas, cooling).

The present synergist, its method of forming and uses, are described in further details by way of non-limiting examples as set forth below.

### Example 1: Introductory Discussion of Present Synergist

A non-limiting example of a chemical structure of a flame retardant synergist of the present disclosure is presented in FIGS. 1A and 1B. The chemical structure differs from those of traditional flame retardant additives. As can be seen in FIGS. 1A and 1B, the chemical structure of the present synergist does not contain any halogen-based elements (i.e. free of halogen and halide which can be harmful to the environment and animals). The synergist contains long molecule chains each (i) having a backbone derived from a triazine-dialdehyde and (ii) branched with 9,10-dihydro-9-oxa-10-phosphaphenanthrene 10-oxide (DOPO) or a derivative thereof. The chemical structure confers high thermal stability with onset degradation temperature as high as about 350° C. Due to the synergist being a long chain molecule, the synergist is of a polymeric nature, i.e. the present synergist is a polymer.

### Example 2: Method of Forming the Present Synergist

The method of producing the present flame retardant synergist involves two steps in a one-pot synthesis. In general, for the structure presented in FIG. 1A and FIG. 1B, the synthesis route is schematically shown in FIG. 2. The synthesis route can be applied to other synergists that is a derivative of the synergist of FIG. 1A. The steps are described as follow.

To a round bottom flask was added 12.5 g 6-methyl-1,3,5-triazine-2,4-diamine (MTD, 0.1 mol), 13.4 g terephthalaldehyde (TPA, 0.1 mol), 100 mL dimethylacetamide (DMAc) and 200 mL ethanol. The mixture was stirred at 100° C. overnight. 43.2 g 9,10-dihydro-9-oxa-10-phosphaphenanthrene 10-oxide (DOPO, 0.2 mol) was then added into the above hot solution. The mixture was then heated to 100° C. and maintained at 100° C. for 48 hrs. After cooling down, the mixture was filtrated and a white precipitate was collected, washed with acetone 3 times, dried and cryo-crushed into fine powder, which is the product abbreviated herein as “MTD/TPA-DOPO”.

### Example 3A: Non-Limiting Examples of Formulations Including the Present Synergist

As mentioned above, the present disclosure also relates to formulations that include a synergist of the present disclosure. A non-limiting example is a formulation that includes the MTD/TPA-DOPO flame retardant synergist mentioned above. The formulations of the present disclosure are capable of significantly enhancing the flame retardancy and mechanical performance of a polymer. The polymer can be, for example, a thermoplastic. A non-limiting example of the thermoplastic can be a polyamide.

In general, the formulation can be used to form a flame retardant polymer composite. The formulation and hence the resultant composite can include a synergist of the present disclosure, a flame retardant agent, and a thermoplastic. The thermoplastic can be any thermoplastic resin. Optionally, the formulation and hence the resultant composite can include a char forming agent and/or a blowing agent. For the sole purpose of demonstration and not to limit the present disclosure, MTD/TPA-DOPO was used as a non-limiting example of the present synergist in the formulations of the present disclosure for forming the present flame retardant polymer composite. The present synergist, such as MTD/TPA-DOPO, can be mixed with the flame retardant agent to enhance flame retardancy of the polymer composite.

The flame retardant property, tensile properties and impact property of the composites were investigated based on UL 94, ASTM D638 and ASTM D256 standards, respectively. For the UL 94 test, a specimen thickness of 3.2 mm was chosen, and the time required for the flame to extinguish after removing the burner (1st burning and 2nd burning) was recorded to differentiate the flame retardant performance of one another. As non-limiting illustrative examples, MTD/TPA-DOPO was formulated with aluminium diethyl phosphinate (ADP) for polyamide 6 (PA6). Control and comparative examples are described and compared below.

### (1) Example for Present Formulation Using MTD/TPA-DOPO

PA6 (Ultramid® B3K, BASF) was used as the polymer, and ADP (Sanwa Flame Retardant Technology Ltd, China) was used as the flame retardant agent. PA6 denotes for polyamide 6. The cryo-crushed MTD/TPA-DOPO and ADP were pre-mixed with weight ratio of 1:3, after which the mixture was melt compounded with PA6 pellets to form the resultant flame retardant polymer composite. The overall loading (two different loadings) of (MTD/TPA-DOPO+ADP) was 6 wt % and 8 wt %, wherein the wt % is based on the total weight of the resultant composite. The composite pellets were then injection moulded into coupons for mechanical and flame retardant testing.

### (2) Control Example

PA6 (Ultramid® B3K, BASF) was used as the polymer, and ADP (Sanwa Flame Retardant Technology Ltd, China) was used as the flame retardant agent. ADP was compounded with PA6 pellets with ADP for two different loading of 10 wt % and 12.5 wt % to form the resultant composites, wherein the wt % is based on the total weight of the resultant composite. The composite pellets were then injection moulded into control coupons for mechanical and flame retardant testing and comparison. In certain non-limiting instances, neat (pure) PA6 was used as a control sample.

### (3) Comparative Example Using Traditional Flame Retardant Agent

PA6 (Ultramid® B3K, BASF) was used as the polymer, and Exolit® OP 1314 was used as the flame retardant agent. The traditional flame retardant agent, if not in powder form, may be cryo-crushed to form into powder. The powder was then compounded with PA6 pellets with Exolit® OP 1314 for two different loading of 10 wt % and 12.5 wt % to form the resultant composites, wherein the wt % is based on the total weight of the resultant composite. The composite pellets were then injection moulded into coupons for mechanical and flame retardant testing and comparison.

### Example 3B: Testing/Characterization Results

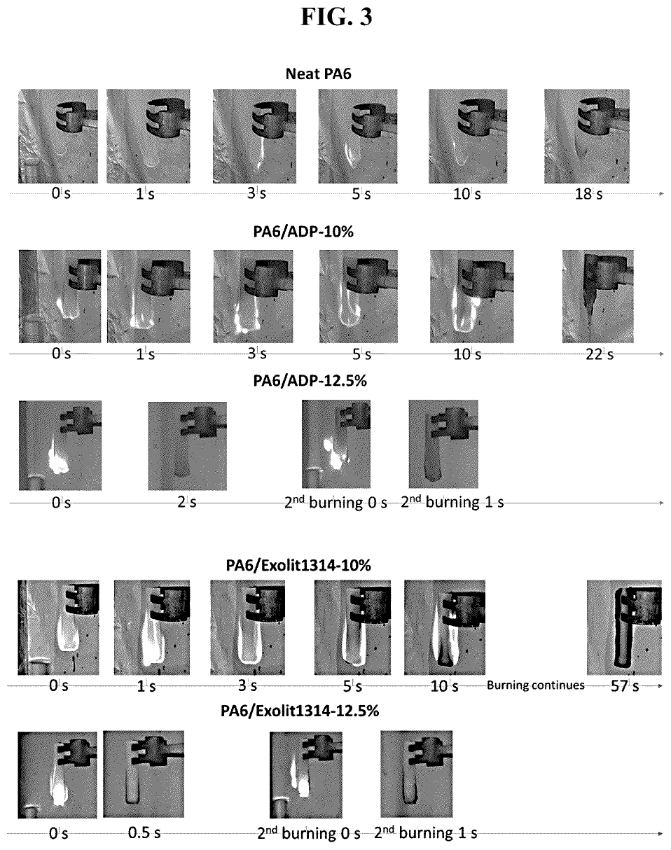

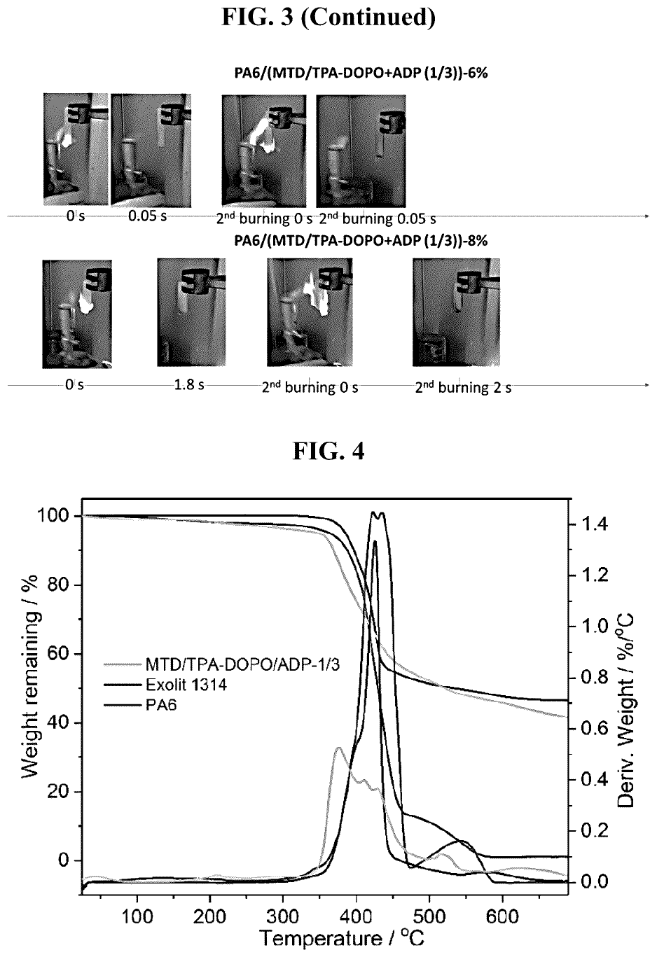

As shown in FIG. 3, despite that the fire goes out in less than 30 s in the neat PA6, dripping occurs during burning. By adding a flame retardant agent of ADP into PA6 as described in the control example, the dripping still occurs for a loading of 10 wt %, but UL94 V0 rate was achieved with a ADP loading of 12.5 wt %. With the addition of a flame retardant of Exolit® OP 1314 into PA6 as described in the comparative example, the burning continues until 57^{th} second without dripping under loading of 10 wt %, and the UL94 V0 rate was achieved with a loading of 12.5 wt %. With the present developed formulation using MTD/TPA-DOPO/ADP at a weight ratio of 1:3 as described in example 3A, the resultant composite with a loading of only 6 wt % is able to survive two burnings with fire extinguishing time of less than 0.1 s, achieving UL94 V0 rate.

The MTD/TPA-DOPO-based formulation largely outperforms the control sample (using ADP) and the comparative sample (using Exolit® OP 1314) in terms of the required loading to achieve UL94 V0 rate, 6 wt % vs. 12.5 wt %. This can be mainly due to: (1) the synergetic effect of inert gas release that dilutes the oxygen, the char formation that protects PA6 matrix and the phosphorus-containing segments scavenging the radicals, and (2) the better matching of the thermal degradation process of MTD/TPA-DOPO/ADP mixture with PA6 matrix than that of Exolit® OP 1314 with PA6 (FIG. 4). It can be seen that the thermal degradation temperature range of MTD/TPA-DOPO/ADP mixture with ratio of 1:3 well covers that of PA6, while that of Exolit® OP 1314 is narrower than PA6. The thermal onset degradation temperature of Exolit® OP 1314 is also slightly higher than that of PA6, suggesting that the PA6 may have started degradation before Exolit® OP 1314 degrades and starts to take flame retardant effect. Moreover, the MTD/TPA-DOPO/ADP-derived composites, especially the one with 8 wt % loading, achieves better mechanical properties (tensile modulus, tensile strength and impact toughness) than the benchmark composite with loading of 12.5 wt % (see FIG. 5).

### Example 4: Summary of Present Synergist

The present flame retardant synergist has a unique chemical structure that is absent of any halogen (i.e. group 17 elements of the chemical periodic table), is polymeric in nature (i.e. a polymer), has high thermal stability and high flame retardant efficacy.

In various examples, the present synergist includes a backbone derived from or formed of (i) chemically reacted triazine and aldehyde, and (ii) one or more branches of 9,10-dihydro-9-oxa-10-phosphaphenanthrene 10-oxide (DOPO) or a derivative thereof.

The polymeric nature of the present synergist arises from the linear long molecule chains of triazine-aldehyde repeating units each having DOPO or a derivative thereof branching from the backbone of repeating units. The number of repeating units can range from 5 to 1000.

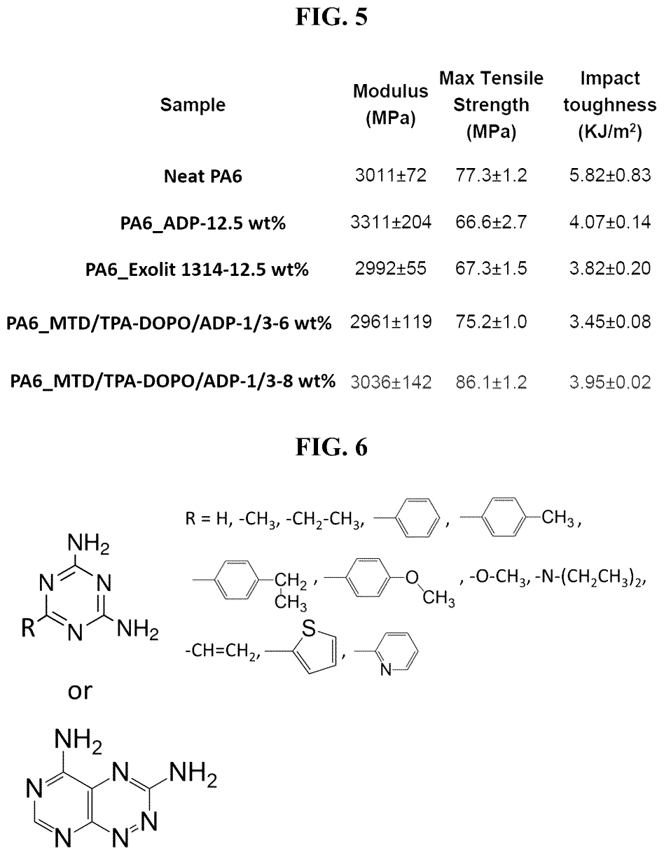

In various non-limiting examples, the triazine can be a triazine, a substituted triazine, or a triazine derivative, that contains at least two amine moiety (i.e. two amino functional groups) and one or more heteroatoms or segments (wherein the segments are denoted by R), as shown in FIG. 6. “R” can be a group (e.g. an inert group) that includes but is not limited to those as shown in FIG. 6.

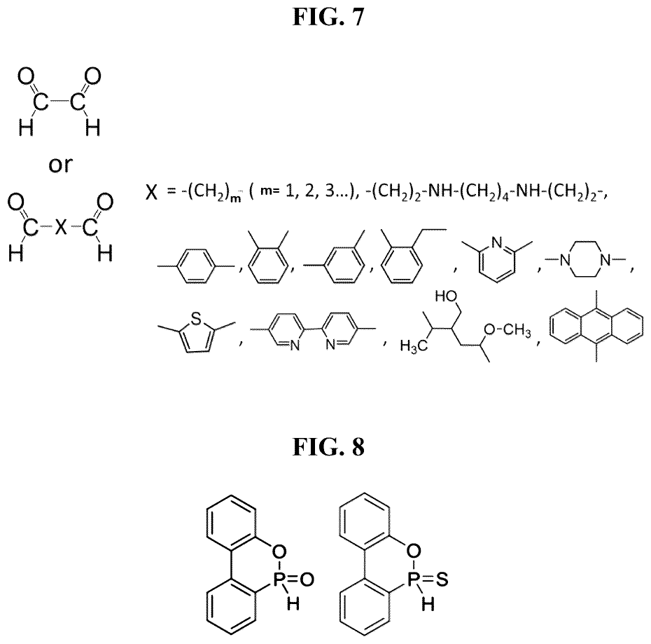

In various examples, the aldehyde is a dialdehyde, or a derivative thereof, containing two aldehyde groups as shown in FIG. 7. The “X” refers to a group that includes but is not limited to those as shown in FIG. 7.

In various examples, the DOPO derivative can contain an active phosphorus-hydrogen (P—H) bond as shown in the left structure of FIG. 8. Another DOPO derivative is shown in the right structure of FIG. 8. The DOPO derivative is not limited to those as shown in FIG. 8.

The present disclosure relates to a method of producing the synergist. The method can be a one-pot reaction route that involves the stoichiometric backbone reaction of a triazine derivative and an aldehyde derivative (1^{st} reaction) followed by further stoichiometric branching reaction with DOPO derivatives (2^{nd} reaction) as shown in FIG. 2.

In various examples, the 1^{st} reaction can involve dissolving the triazine (or a derivative) and aldehyde (or a derivative) in a mixture of solvent, for example, dimethylacetamide (DMAc) and ethanol with a volume ratio ranging from 2:1 to 1:2. In certain non-limiting instances, the mixture of solvent can include DMAc and ethanol at a volume ratio of 1:2.

In various examples, the 1^{st} reaction can be carried out at a temperature ranging from 80 to 150° C., for example, 100° C. In various examples, the 1^{st} reaction can be carried out for a reaction duration of more than 12 hrs, for example, 20 hrs.

In various examples, the 2^{nd} reaction involves addition of a stoichiometric amount of DOPO (or a DOPO derivative) directly into the 1^{st} reaction mixture. The 2nd reaction can be carried out at a temperature ranging from 80 to 150° C., for example, 100° C. In various examples, the 1^{st} reaction can be carried out for a reaction duration of at least 48 hrs.

In various examples, the formulations of the present disclosure containing the present synergist, for forming the resultant flame retardant polymer composite, are capable of significantly enhancing the flame retardant and mechanical performance of polymers, such as thermoplastics. The polymers, wherein such polymers can include but is not limited to polyamides, can have onset degradation temperature slightly higher than that of traditionally developed flame retardant formulations.

In various examples, the formulations and hence the resultant flame retardant polymer composite can comprise the present flame retardant synergist and a flame retardant agent, optionally a char forming agent, and optionally a blowing agent.

In various examples, the enhanced flame retardant and mechanical performance can be achieved even with a lower loading of the present synergist as compared to the loading required for a traditional flame retardant agent to achieve UL94 V0 rate. Also, the better mechanical properties of composites of the present disclosure as compared to polymer composites incorporated with traditional flame retardant agent are achieved under the premise of UL 94 V0 rate.

### Example 5: Commercial and Potential Applications

The chemical structure of the presently developed flame retardant synergist and the formulations developed herein demonstrate significant improvement over the various control and comparative samples as described in examples 3A and 3B. The improvement includes a lower flame retardant synergist dosage required to achieve UL94 V0 rate, and better (or no compromise of) mechanical properties under the premise of V0 rate.

While the present disclosure has been particularly shown and described with reference to specific embodiments, it should be understood by those skilled in the art that various changes in form and detail may be made therein without departing from the spirit and scope of the present disclosure as defined by the appended claims. The scope of the present disclosure is thus indicated by the appended claims and all changes which come within the meaning and range of equivalency of the claims are therefore intended to be embraced.

1. A flame retardant synergist comprising:
a repeating unit comprising:
a backbone represented by a formula of: 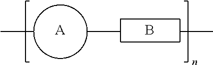
wherein moiety A is derived from a substituted triazine having at least two amino groups;
wherein moiety B is derived from a dialdehyde having a terminal aldehyde;
wherein moiety A and moiety B are bonded via a —C—N— linkage formed from having one of the at least two amino groups reacted with the terminal aldehyde;
wherein n ranges from 5 to 1000; and
one or more side units extending from the backbone, wherein the one or more side units are derived from 9,10-dihydro-9-oxa-10-phosphaphenanthrene 10-oxide or a derivative thereof.

2. The flame retardant synergist of claim 1, wherein the flame retardant synergist is absent of a halogen and a halide.

3. The flame retardant synergist of claim 1, wherein the substituted triazine is: 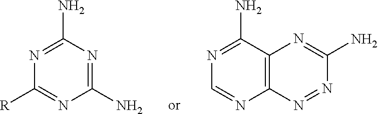
wherein R is selected from the group consisting of hydrogen, C₁₋₆alkyl, —CH═CH₂,

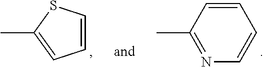

4. The flame retardant synergist of claim 1, wherein the dialdehyde is: 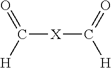
wherein X is selected from the group consisting of a bond, —(CH₂)ₘ—, —(CH₂)₂—NH—(CH₂)₄—NH—(CH₂)₂—, 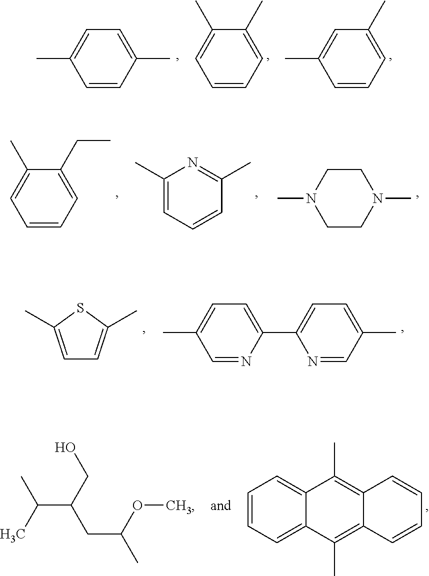
and
wherein m ranges from 1 to 10.

5. The flame retardant synergist of claim 1, wherein the one or more side units are derived from

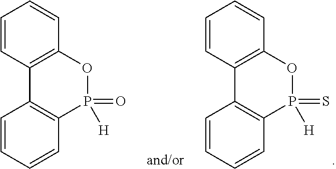 [SMILES: O=[PH]1Oc2ccccc2-c2ccccc21 ; S=[PH]1Oc2ccccc2-c2ccccc21]

6. The flame retardant synergist of claim 1, wherein the flame retardant synergist comprises: 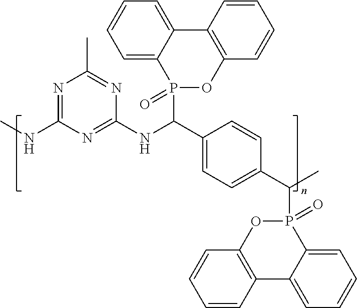
wherein n ranges from 5 to 1000.

7. A method of forming the flame retardant synergist of claim 1, the method comprising:
dissolving a substituted triazine and a dialdehyde in a mixture of organic solvents, wherein the substituted triazine has at least two amino groups and the dialdehyde has a terminal aldehyde to form a first reaction mixture; and
mixing 9,10-dihydro-9-oxa-10-phosphaphenanthrene 10-oxide or a derivative thereof with the first reaction mixture.

8. The method of claim 7, wherein the mixture of organic solvents comprises an alcohol and dimethylacetamide.

9. The method of claim 7, wherein the dissolving and/or the mixing is carried out at a temperature of 80° C. to 150° C.

10. The method of claim 7, wherein the dissolving is carried out for a duration of more than 12 hours.

11. The method of claim 7, wherein the mixing is carried out for a duration of at least 48 hours.

12. A flame retardant polymer composite comprising:
a polymer;
the flame retardant synergist of claim 1; and
a flame retardant additive.

13. The flame retardant polymer composite of claim 12, wherein the polymer is a thermoplastic.

14. The flame retardant polymer composite of claim 12, wherein the thermoplastic comprises a polyamide or a polyethylene.

15. The flame retardant polymer composite of claim 12, further comprising a char forming agent and/or a blowing agent.

16. A method of producing the flame retardant polymer composite of claim 12, the method comprising:
mixing the flame retardant synergist of claim 1 with a flame retardant agent to form a pre-mix; and
compounding the pre-mix with a polymer to form the flame retardant polymer composite.

17. The method of claim 16, wherein the flame retardant synergist and the flame retardant agent are mixed in weight ratio of 1:3 to 1:4.

18. The method of claim 16, wherein the loading of the flame retardant synergist and the flame retardant additive in the flame retardant polymer composite is less than 12.5 wt %.
